(19) United States
(12) Patent Application Publication
(10) Pub. No.: US 2016/0277892 A1
(43) Pub. Date: Sep. 22, 2016

(54) PROXIMITY BASED MESSAGING PLATFORM

(71) Applicant: Imagine2Max, Marietta, GA (US)

(72) Inventors: ANGELA WALKER, MARIETTA, GA (US); YASSINE SBITI, MARIETTA, GA (US); SHELBY SWITZER, MARIETTA, GA (US)

(21) Appl. No.: 15/071,028

(22) Filed: Mar. 15, 2016

Related U.S. Application Data
(60) Provisional application No. 62/133,859, filed on Mar. 16, 2015.

(51) Int. Cl. H04W 4/02; H04M 1/725; H04W 4/22; G08B 21/02; H04L 12/58

(52) U.S. Cl. CPC H04W 4/023; G08B 21/02; H04L 51/20; H04W 4/22; H04M 1/72538; H04M 1/72552; H04M 1/72555

(57) ABSTRACT

Embodiments of the present disclosure may provide a platform that enables a user to issue a mass message to mobile telecommunications devices within a particular radius of the users' location. The platform may be configured to transmit the communication to the proximate mobile devices without the user providing the contact information for the proximate mobile devices. The communication may be embodied as, but not limited to, for example, a Multimedia Messaging Service. The platform may be enabled to provide, along with the communication, a time-stamp and geo-coordinates tied to the user issuing the communication. In turn, based on the geo-coordinates and the time stamp, the platform may calculate a radius in which to issue the communication. The platform may then determine which mobile telecommunications devices are within the radius, retrieve the contact information for the mobile devices, and transmit, or cause a transmission of, the communication.

### RELATED APPLICATION(S)

Under provisions of 35 U.S.C. §119(e), the Applicant(s) claim the benefit of U.S. provisional application No. 62/133,859 filed Mar. 16, 2015 which is incorporated herein by reference.

It is intended that each of the referenced applications may be applicable to the concepts and embodiments disclosed herein, even if such concepts and embodiments are disclosed in the referenced applications with different limitations and configurations and described using different examples and terminology.

### FIELD OF DISCLOSURE

The present disclosure generally relates to the field of mobile device telecommunications multimedia messaging services.

### BACKGROUND

Once law enforcement determines that a child has been abducted and the abduction meets AMBER Alert criteria, law enforcement issues an AMBER Alert and notifies broadcasters and state transportation officials. AMBER Alerts interrupt regular programming and are broadcast on radio and television and on highway signs. AMBER Alerts can also be issued on lottery tickets, wireless devices such as mobile phones, and over the Internet.

As of Jan. 1, 2013, federal legislation has enabled and permitted AMBER Alerts to be automatically sent through the Wireless Emergency Alerts (WEA) program to millions of cell phone users. If you have a WEA-enabled phone, you are automatically enrolled for the three alerts, classified as President, Imminent Threat and AMBER Alerts. The addition of AMBER Alerts to this notification system is a result of a partnership between CTIA and the wireless industry, the Federal Communications Commission (FCC), and Federal Emergency Management Agency (FEMA).

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicants. The Applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates one possible operating environment for providing embodiments of the proximity based messaging platform;

FIG. 2 is a flow chart of a method for providing the proximity based messaging platform; and

FIGS. 3-9 are screenshots of an embodiment of the proximity based messaging;

FIG. 10 is a block diagram of a system including a computing device for performing the method of FIG. 2.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. §112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of alert messages, embodiments of the present disclosure are not limited to use only in this context.

I. Platform Overview

This overview is provided to introduce a selection of concepts in a simplified form that are further described below. This overview is not intended to identify key features or essential features of the claimed subject matter. Nor is this overview intended to be used to limit the claimed subject matter's scope.

Embodiments of the present disclosure may provide a platform that enables a user to issue a mass message (hereinafter referred to as a “communication”) to mobile telecommunications devices (e.g., a mobile phone) within a particular radius of the users' location. As will be detailed below, the platform may be configured to transmit the communication to the proximate mobile devices without the user providing the contact information for the proximate mobile devices. The communication may be embodied as, but not limited to, for example, a Multimedia Messaging Service (MMS). The communication may comprise, but not be limited to, for example, multimedia content and textual content.

The platform may be enabled to provide, along with the communication, a time-stamp and geo-coordinates tied to the user issuing the communication. In turn, based on the geo-coordinates and the time stamp, the platform may calculate a radius in which to issue the communication. The platform may then determine which mobile telecommunications devices are within the radius, retrieve the contact information for the mobile devices, and transmit, or cause a transmission of, the communication.

The user may employ the platform of the present disclosure to issue, for example, important alerts (e.g., an MMS communication including multimedia and textual data) to mobile telecommunications devices within a proximity to the user without having the contact information for those mobile devices. In some embodiments, the platform may be configured to employ, at least in part, existing telecommunications infrastructure to issue the communication. The telecommunications infrastructure may include, but not limited to, telecom and emergency communication channels similar to those to be utilized by, for example, the Wireless Emergency Alerts (WEA) program. In some embodiments, platform infrastructure (e.g., a server) may be employed.

In further embodiments, the platform may be configured to employ, at least in part, existing mobile device platforms to issue the communication. The mobile device platforms may include, but not be limited to, for example, mobile device operating systems (e.g., Android, Windows Mobile, and iOS) and social media platforms (e.g., Facebook™, Twitter™, Google+™, Instagram™, and the like) associated with the user. The platform of the present disclosure may integrate with the mobile device platforms via, for example, an Application Programming Interface (API). The API may enable the present platform to exchange information with the existing mobile device platform.

It is well-known that many mobile device platforms are configured to obtain and store user location data. Using location detection components of the mobile device, the mobile device platform may register a location of the user and associate the location with the user's profile data. Accordingly, by interfacing with these existing mobile device platforms, the platform of the present disclosure may be configured to retrieve location data collected by the mobile device platform. The interface between the present platform and the existing mobile device platforms may be illustrated by way of the following non-limiting examples.

For example, through an API interfacing with the mobile device's operating system, the platform may retrieve the various user data acquired by the operating system. The data may include, but not be limited to, for example, the user's location, phone number, name, and a time. Through an API interfacing with, for example, the user's social media platforms, the platform may retrieve the various data associated with the user as well as the data associated with members of the user's network. Data retrieved through the API interfacing with the user's social media platforms may include, but not be limited to, for example, the names, relations, pictures and other profile data associated with the user, as well as the profile data associated with the user's network connections.

In some embodiments, the proximity based messaging platform of the present disclosure may be embodied as an application, plug-in, or add-on to, for example, a social media platform. In this way, the proximity based messaging platform may have access to not only the user's profile data, but the entire network of profile data as available through the user's social media platform. The profile data may include the user's location data as well as the location data associated with the members of the user's network. In this way, the platform may determine which members (and their corresponding mobile devices) are within a particular proximity (i.e., the radius) to the user and issue communications to those mobile devices accordingly. Still consistent with embodiments of the present disclosure, the communication may be issued employing a communication interface provided by the social media platform.

Having the user's location data, the platform may be configured to work with existing mobile devices platforms and telecom infrastructure to, for example, transmit an alert to all mobile devices in his or her immediate vicinity. In some embodiments, the proximity based messaging platform may issue a MMS through existing telecom and emergency channels (e.g., the WEA program). In other embodiments, the platform may retrieve the user's social media platform data and distribute the message to all network connections determined to be within the vicinity. Such communication may be issued by means of MMS (by retrieving the members' phone number from corresponding profile data) or an interface facilitated by the social media platform (e.g., posting or messaging through the social media platform on behalf of the user).

It is anticipated that, in instances where the communication is associated with a crime or emergency situation, the telecom, emergency channels, and social media platforms may integrate with the platform of the present disclosure to include a capability to communicate with all members within the user's vicinity regardless of the user's network connection with such members. In this scenario, the platform of the present disclosure may be enabled to transmit a message to a network larger than that of the platform user.

Still consistent with yet further embodiments of the present disclosure, the proximity based messaging platform may be employed to communicate data captured by the user to an emergency response agency (e.g., police department, fire department, ambulance transport and the like). The communication protocol may correspond to a protocol of communication accepted by the emergency response agency.

Through the protocol, the platform may communicate pictures, videos, and text to the emergency agency. As will be detailed below, the emergency response agency may employ, for example, a distribution node (e.g., telecommunications center) to communicate the received data from the platform to parties who may handle the emergency (i.e., police, fire, ambulance, etc.). In addition, it is anticipated that the emergency response agency may have the authority to cause a transition of the received message to a plurality of mobile devices within a dynamically determined radius of the reported alert (based on, for example, the location data provided with the received message from the platform user). In this way, the proximity based messaging platform not only encourages users to become more vigilant and responsible community members, but also empowers the users to utilize the existing infrastructure and devices to actively report and help resolve cases related, but not limited to, child abductions, kidnappings, and other crimes.

Embodiments of the present disclosure may further provide notifications to platform users regarding crime in an physical area associated with the user. For example, the platform may be configured to communicate with various databases (e.g., government reporting databases) to retrieve information associated with, for example, crimes and accidents. This information may be retrieved and compiled into various zones. When the platform detects that a user is located within a zone with a calculated higher crime-rate, the platform may be configured to issue an alert to the user and, in some embodiments, to the user's contacts if so specified by the user. In various embodiments, and as will be detailed below, the platform may be configured to display a map of incidents to the user so that the user may be view the incidents reported in a particular area.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

II. Platform Configuration

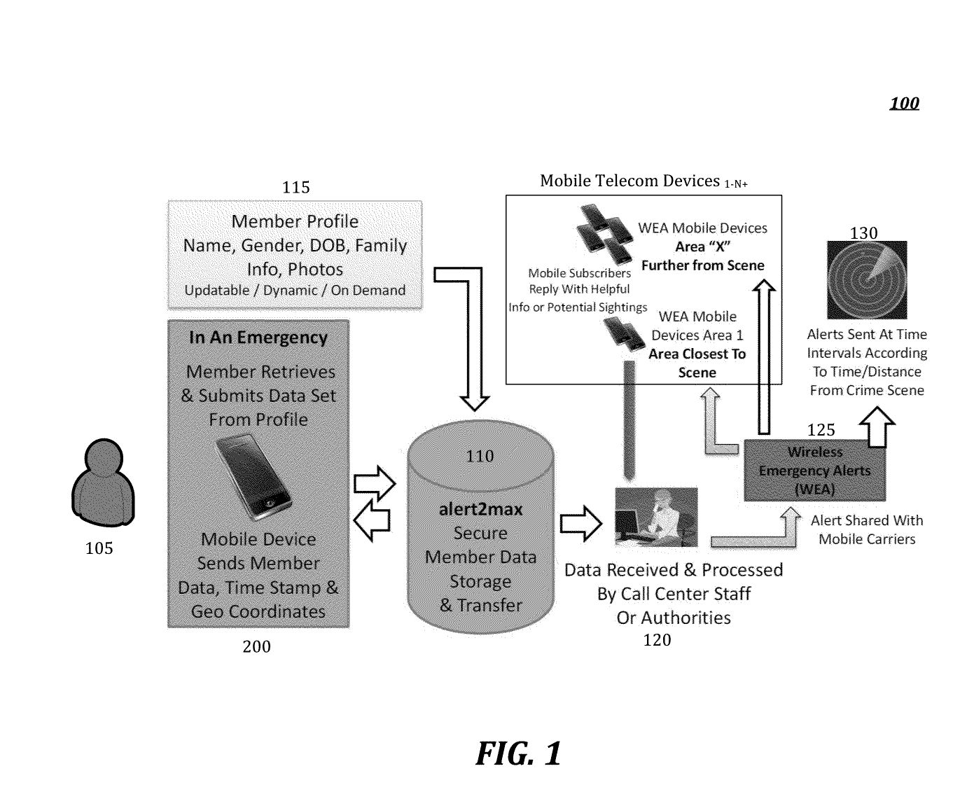

FIG. 1 illustrates one possible operating environment through which a platform consistent with embodiments of the present disclosure may be provided. By way of non-limiting example, a proximity based messaging platform 100 may be hosted on a centralized server 110. Server 110 may be, for example, hosted by a cloud computing service. A user 105 may access platform 100 through a software application. The software application may be embodied as, for example, but not be limited to, a website, a web application, a desktop application, and a mobile application compatible with a computing device 1000. As will be detailed below, in embodiments where the software comprises a mobile phone application, platform 100 may be enabled to receive device location information.

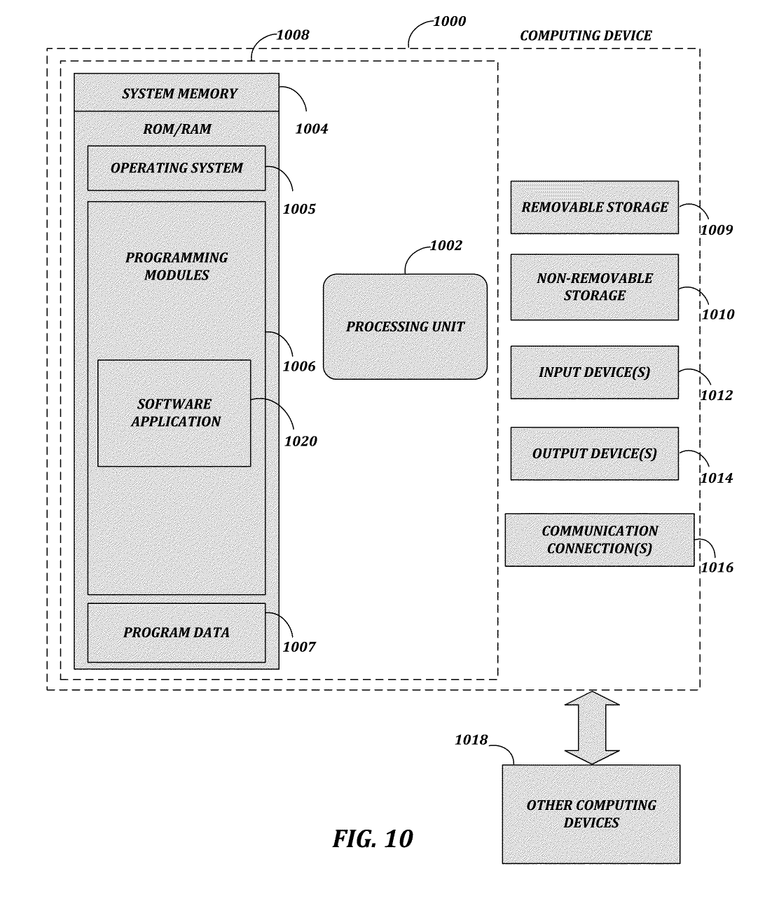

One possible embodiment of the software application may be provided by the alter2Max™ suite of products and services provided by Imgaine2Max Corp. As will be detailed with reference to FIG. 10 below, the computing device through which the platform may be accessed may comprise, but not be limited to, for example, a desktop computer, laptop, a tablet, or mobile telecommunications device.

Centralized server 110 may be used to receive, store, and communicate data received from user 105. Data received from user 105 may be associated with a user profile 115 stored on platform 100. User profile 115 may include data such as the users bibliographical and demographical information (e.g., name, gender, address, mobile device information, phone number, Date of Birth, family information, pictures of the family members, phone number of the family members, address of the family members, physical description of the family members and the like).

In some embodiments, at least portions of user profile 115 may be automatically populated by the platform. For example, platform 100 may enable user 105 to register his login credentials for each social media platform from which user data and the data of the user's network connections may be obtained. In some embodiments, platform 100 may be registered as an authorized application for each social media platform and receive the sufficient access privileges and permissions from user 105. In this way, server 110 may be granted access to each social media platform, retrieve profile data, and communicate content on the user's behalf.

Still consistent with embodiments of the present disclosure, profile 115 may be associated with a group of people (e.g., a family). Each member in the group may have a separate login into platform 100. However, platform 100 may enable each member to register their corresponding profile information into common profile 115. Each group member may install, for example, the application to their mobile device. In some embodiments, using the mobile application and the corresponding mobile devices location detection components, platform 100 may track the group member's location and display the information within profile 115.

Consistent with embodiments of the present disclosure, platform 100 may enable a user to issue communications to a plurality of mobile telecommunications devices 1-N+. Accordingly, platform 100 may enable the user to register his login credentials for each social media platform to which user 105 would like content published via the platform. In some embodiments, platform 100 may be registered as an authorized application for each social media platform and receive the sufficient access privileges and permissions from the user. In this way, server 110 may be granted access to each social media platform and retrieve data (as well as publish content) on the user's behalf.

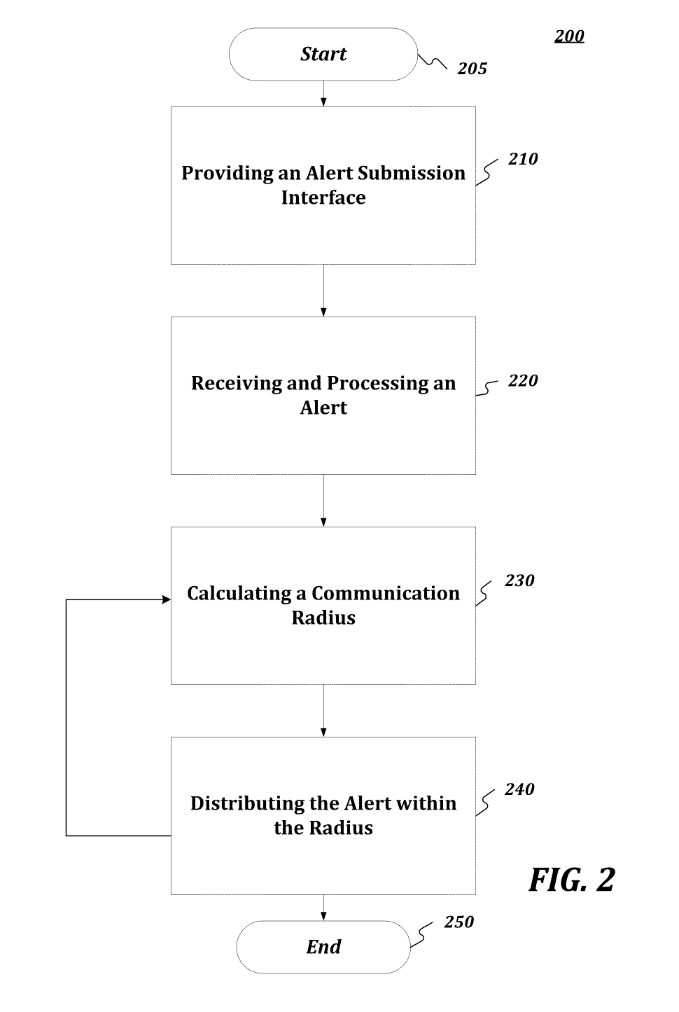

As will be detailed with reference with FIG. 2, once an incident is reported, an alert may first be received by a dispatch center 120. Dispatch center 120 may be proprietary to platform 100. In various embodiments, however, the dispatch center 120 may be in operative communication with mobile carriers and emergency WEA protocol compliant systems. This may enable platform 100 to either: 1) issue its own alert to contacts associated with the user or those mobile devices determined to be within proximity to user 105, and/or 2) communicate with mobile carriers and/or WEA protocol compliant systems (e.g., emergency services) in furtherance of issuing an alert to mobile devices in proximity to user 105. As will be detailed below, dispatch center 120 may issue alerts 130 on a time-based and/or radius-based basis in conjunction with or without third party centers (e.g., mobile carriers or WEA systems).

III. Platform Operation

FIG. 2 is a flow chart setting forth the general stages involved in a method 200 consistent with an embodiment of the disclosure for providing proximity based messaging. Method 200 may be implemented using a computing device 1000 as described in more detail below with respect to FIG. 10.

Although method 200 has been described to be performed by a computing device 1000, it should be understood that, in some embodiments, different operations may be performed by different networked elements in operative communication with computing device 1000. For example, server 110 may be employed in the performance of some or all of the stages in method 200. Moreover, server 110 may be configured much like computing device 1000.

Although the stages illustrated by the flow charts are disclosed in a particular order, it should be understood that the order is disclosed for illustrative purposes only. Stages may be combined, separated, reordered, and various intermediary stages may exist. Accordingly, it should be understood that the various stages illustrated within the flow chart may be, in various embodiments, performed in arrangements that differ from the ones illustrated. Moreover, various stages may be added or removed from the flow charts without altering or deterring from the fundamental scope of the depicted methods and systems disclosed herein. Ways to implement the stages of method 200 will be described in greater detail below.

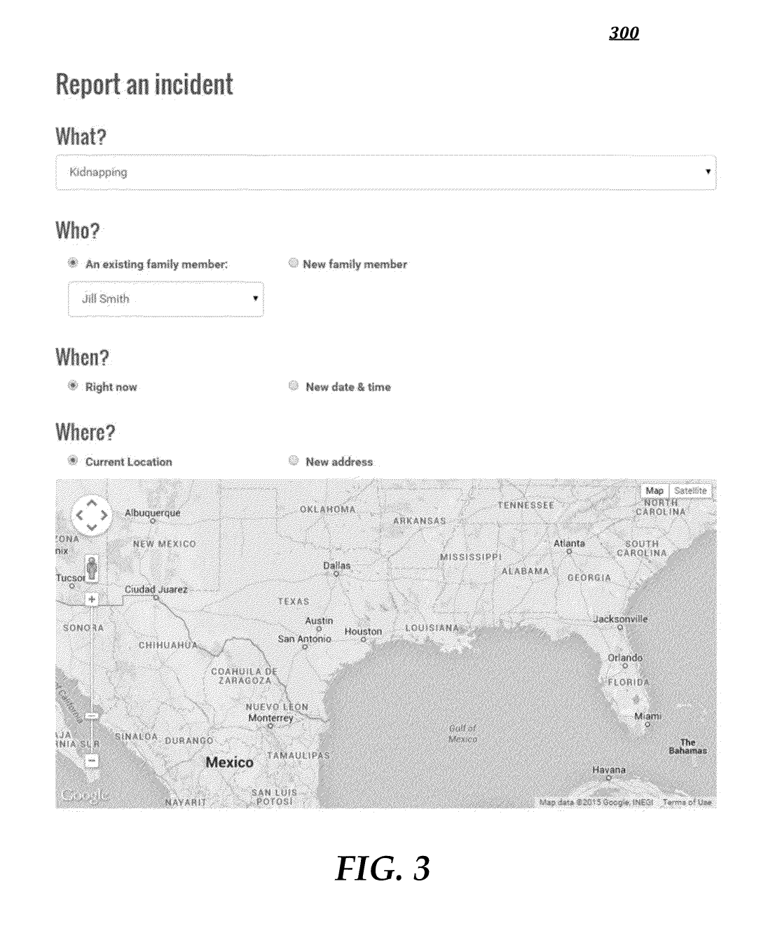

Method 200 may begin at starting block 205 and proceed to stage 210 where computing device 1000 may provide an alter issuance interface. The alert issuance interface may enable a user 105 to issue an alert through platform 100. FIG. 3 illustrates an embodiments of an alert issuance interface 300. For example, user 105 may access platform 100 through an internet enabled device (e.g., mobile device application residing on computing device 1000). Once accessed, user 105 may be provided an interface 300 to initiate a communication (hereinafter referred to as “alert”).

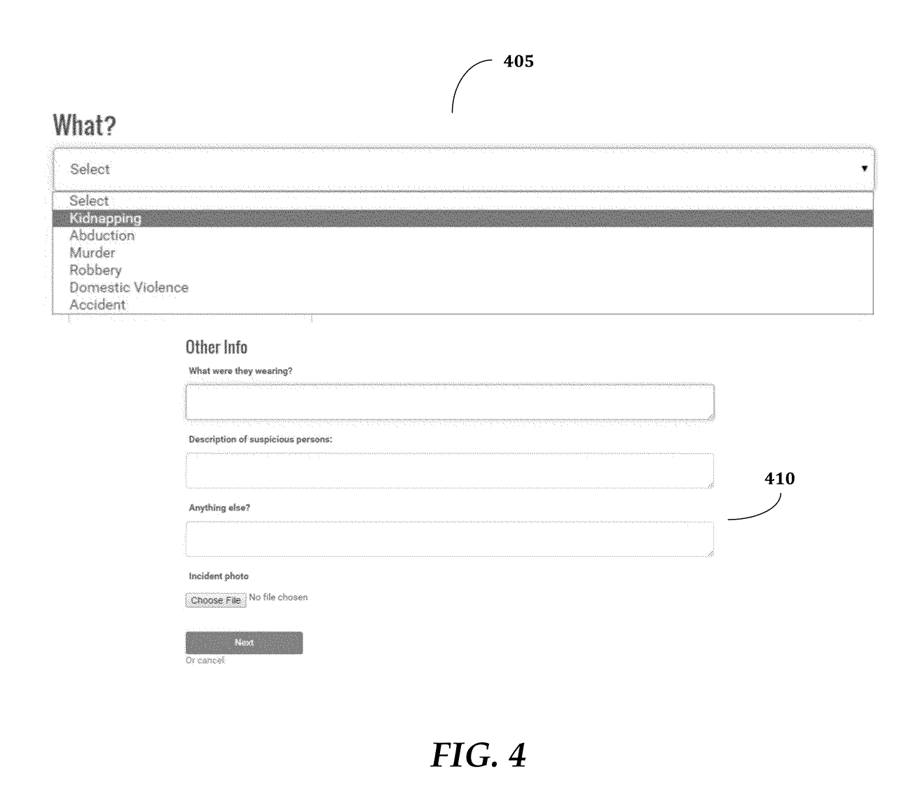

In some embodiments, as illustrated in FIG. 4, the alert may be issued for a plurality of events 405, including, but not limited to, for example, missing persons, abductions, accidents, or any other type of crime or emergency. Moreover, additional details 410 specific to the event type may be requested.

In some embodiments, profile 115 may be used in conjunction with interface 300 to identify a person who may be, for example, missing, abducted, other otherwise associated with a crime. For non-limiting illustrative purposes, the present disclosure shall refer to the person as a ‘missing’ person for which user 105 desires to issue an alert through platform 100. Furthermore, although the term ‘alert’ is used, platform 100 may be used for non-alert mass messaging systems.

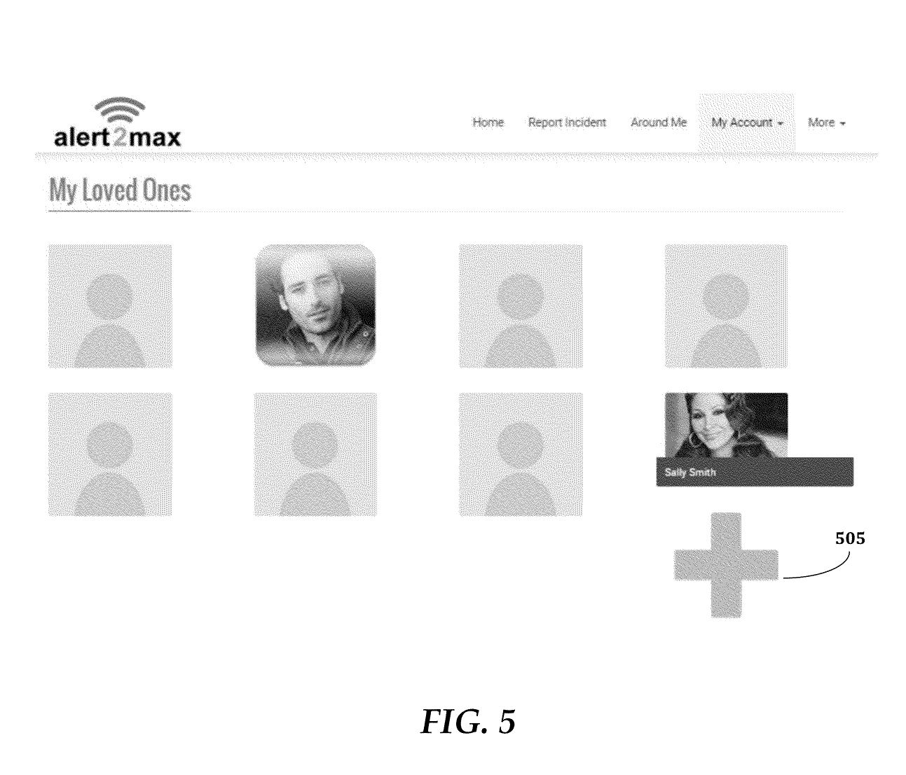

In the scenario where the missing person has their information registered in profile 115, platform 100 may quickly retrieve data associated with the person and append the data to the alert. FIG. 5 illustrates an interface comprised of a plurality of profiles created in advance of an incident. A profile may be added by a user's selection of button 505. In some embodiments, upon creation of an incident associated with a person, the profile for the person may be created and stored for subsequent use. Moreover, upon creation of the incident associated with the person, field 505 as illustrated in FIG. 5 may be populated with information associated with the incident. In this way, incident information may be paired with profile information.

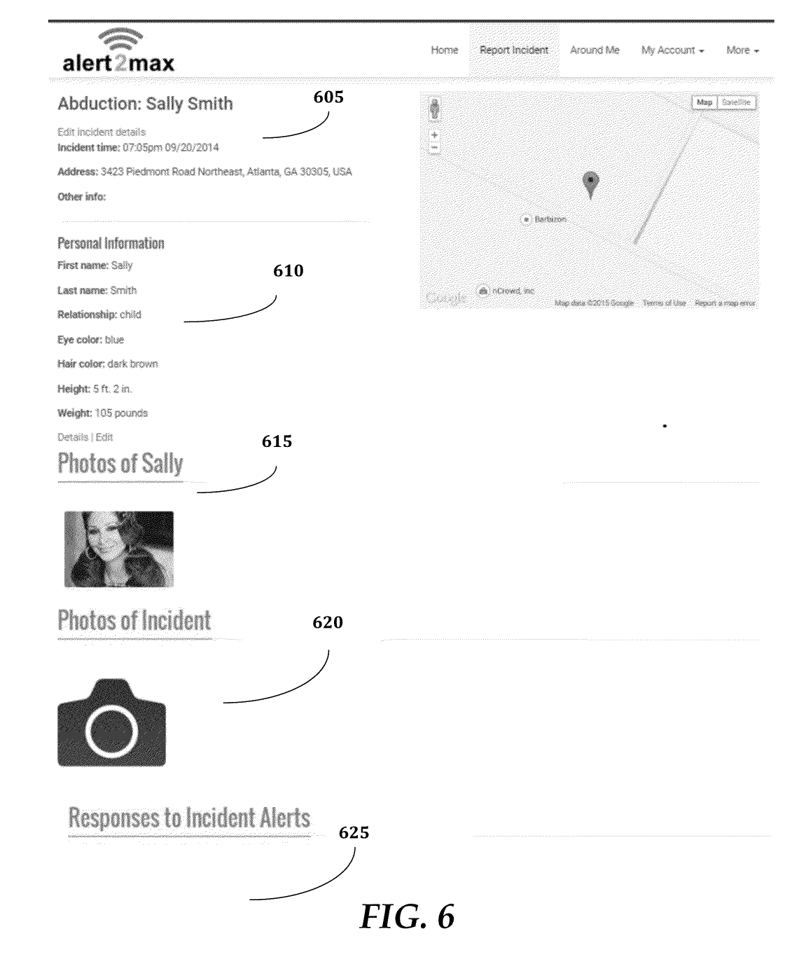

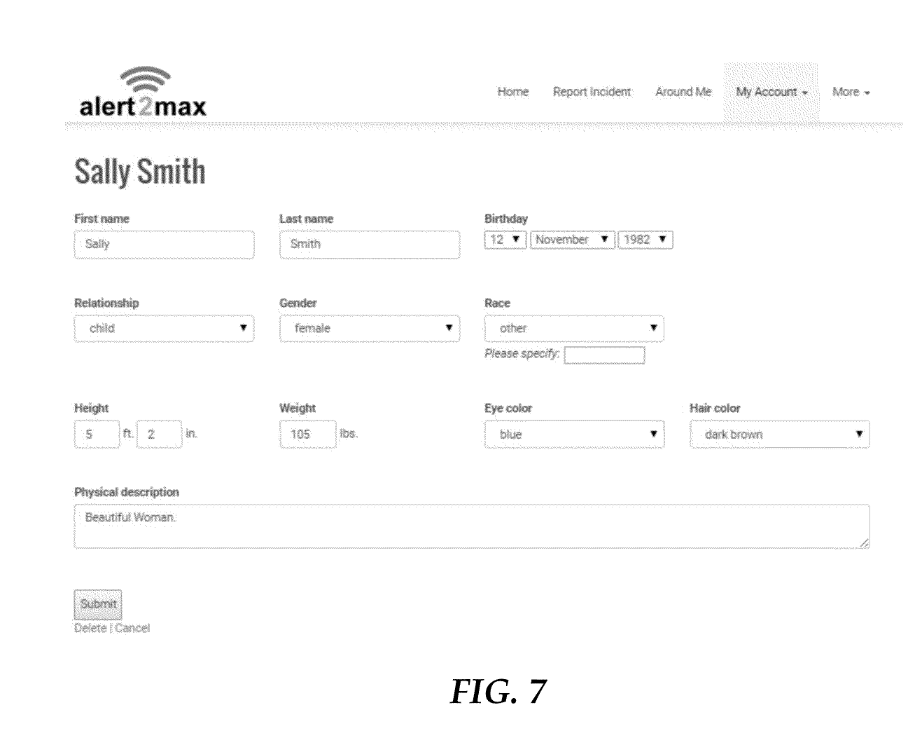

FIG. 6 illustrates an interface in which a person's profile may be set and retrieved for inclusion in an incident report. Such profile may be created at the time of reporting the incident or in advance of the incident. For example, a picture of the person 515, a description of the person 510, and a last known location of the person may all have been previously registered by the person or created at the time of incident reporting. Moreover, the profile may include field 635 in which responses to the incident are stored. As illustrated in FIG. 7, a detailed description of the person may be provided to platform 100.

In some embodiments, the last known location of the missing person may be obtained by the platform by, for example, reading the last known location data of the person's mobile device as it was registered with the platform (e.g., via integrations with, for example, existing mobile device platforms that the person has registered with platform 100).

In yet further embodiments, upon issuance of the alert, platform 100 may be enabled to ping a mobile device of the missing person, via the integrated applications, for the mobile device's location. In embodiments where platform 100 is integrated with existing mobile device platforms associated with the missing person (e.g., mobile phone operating system or a social media platform), platform 100 may retrieve the latest available location data associated with the missing person's mobile device through such platforms. In this way, platform 100 may associate the missing person's location (in addition to user 105's location) with the issued alert.

Referring back to FIGS. 3-4, and as will be detailed below, the alert may comprise, among other things, information regarding a person (e.g., name/picture/description), information regarding the incident (e.g., pictures/descriptions of related parties or elements), a location of user 105 when submitting the alert, the last known location of the missing person, a time stamp of the incident, as well as any other information submitted by user 105. Although much of this information may be automatically populated by platform 100 due to user 105's and/or missing person's prior registration with platform 100, interface 300 may enable user to manually input the information.

The user-inputted information may comprise, but not be limited to, for example, an uploaded photo, personal and/or event information. If the alert is for a crime, the information may further indicate the type of crime, description of a criminal, description of a victim, description of a vehicle involved, witness statements, and any other textual or graphical information associated therewith.

In addition, platform 100 may be enabled to append time and location information to the alert prior to user 105's submission of the alert. The location and time information may be automatically retrieved from the device through which user 105 is interfacing with the platform. In other embodiments, user 105 may be prompted to manually provide the location (via, for example, a graphical map interface) and time of the reported incident.

In some embodiments, user 105 may simply send a MMS, using his or her mobile device (e.g., computing device 1000) to platform 100. Platform 100 may be configured to receive an MMS at a designated telecommunications number or address. The MMS may be manually composed and communicated to server 110 by the user through the designated number or address. Accordingly, in these scenarios, the alert submission interface 300 may be comprised solely of such number or address. In alternative embodiments, platform 100 may be enabled to cause computing device 1000 to submit the MMS (e.g., the alert) on the user's behalf. The MMS may comprise data and meta-data that is inputted and/or automatically retrieved by platform 100.

Once alert is submitted by user 105, the alert may be received and processed by server 110 in stage 220. Processing of the alter may comprise, but not be limited to, for example, the data retrieval operations described with reference to stage 205 of method 200. For example, while the data (e.g., missing person data, location data, and time data) has been disclosed to be submitted along with the alert, in some embodiments, such data may be retrieved by server 110 after the user 105's submission of the alter to server 110. Accordingly, computing device 1000 and server 110 may be the same device, or separate devices, depending on a preferred implementation of the platform provider.

Once processed, server 110 may communicate the alert to, for example, a dispatch center 120. The dispatch center 120 may assess the alert and distribute the alert. In some embodiments, the alert may be distrusted in accordance to WEA protocols 125. Accordingly, consistent with embodiments of the present disclosure, the distribution of the alert may be performed in conjunction with, for example, regular telecommunication services, emergency services, and their corresponding communication channels. Still consistent with embodiments of the present disclosure, existing mobile device platforms (e.g., mobile device operating systems and social media platforms) may also be employed in the communication of the alert, as detailed in the above description.

The communication of the alert may be based on a dynamic radius 130. The radius may be dynamic in the sense that it is calculated based on, for example, but not limited to, the following factors: a nature of the alert (e.g., severity type, elements involved, etc.), a location of the alert, and a time elapsed since the alert has been resolved. Radius 105's may be extended in a geographical area from user 105's location and all mobile telecommunications devices_{1-N+} within the radius may be determined in accordance to the embodiments disclosed herein. Moreover, in embodiments where the last known location of the missing person is available, a radius may be similarly calculated from the last known location and all mobile telecommunications devices_{1-N+} within the radius may be determined in accordance to the embodiments disclosed herein.

Although method 200 shows the radius to be calculated in stage 230, it is anticipated that the radius may be calculated by server 110 or computing device 1000, however the case may be, prior to the transmission of the alert to dispatch center 120. As such, the alert may be communicated to dispatch center along with the radius for distribution. In other embodiments, the radius may be calculated by the dispatch center 120. In some embodiments, when the incident goes unresolved for a period exceeding a predetermined amount of time, the alert may be issued by geographical region rather than radius from original incident. In this way, neighboring jurisdictions may be notified about the incident in due course.

Once mobile telecommunications devices_{1-N+} have been calculated, platform 100 may cause a communication of the alert in stage 240 via, for example, MMS. In other embodiments, the alert may be communicated via, for example, other existing mobile device platforms.

The alert may be comprised of the initial message communicated by user 105. Alternatively, the alert may be a derivative form of the message initial communicated by the user. For example, the alert could be a modified or shortened version of the initial communication from user 105, as determined by dispatch center 120.

Furthermore, platform 100 may append a reply-to field in alert. The reply-to field may comprise a destination associated with platform 100 (e.g., number or phone number). For example, in embodiments where the alert was issued via MMS, the recipient of the alert may be enabled to reply to the MMS with information regarding the missing person. The reply may be received by platform 100. The reply may comprise, but not be limited to, pictures and/or text communicated by the user, the platform 100, via MMS.

In other embodiments, the recipient of the alert may be directed to platform 100 via, for example, a hyper-link embedded in the alert. The hyper-link may lead the recipient to an access point to platform 100 (e.g., web or mobile application). Through the access point, the recipient may submit the reply with any relevant information.

Platform 100 may receive the reply back at dispatch center 120. Dispatch center 120 may assess the information and provide it to relevant parties (e.g., user 105 and/or emergency personnel) to help resolve the issue. Once the issue has been resolved (either by dispatch center 120 or user 105), platform 100 may mark the alert as resolved. If the alert has not been marked as resolved within a predetermined amount of time, a larger radius may be recalculated (e.g., based on, for example, the “time elapsed” factor) and retransmit the alert to mobile devices within the newly calculated radius.

The platform may be embodied as, for example, but not be limited to, a website, a web application, a desktop application, and a mobile application compatible with a computing device. The computing device may comprise, but not be limited to, a desktop computer, laptop, a tablet, or mobile telecommunications device. Moreover, the platform may be hosted on a centralized server, such as, for example, a cloud computing service. Although method 200 has been described to be performed by a computing device 1000, it should be understood that, in some embodiments, different operations may be performed by different networked elements in operative communication with computing device 1000.

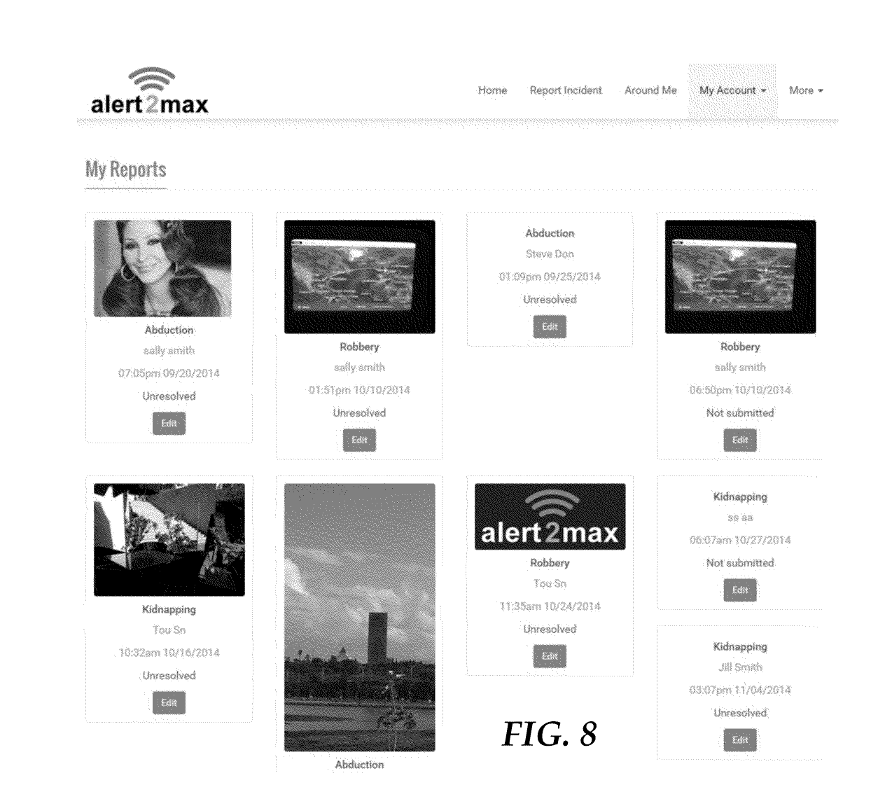

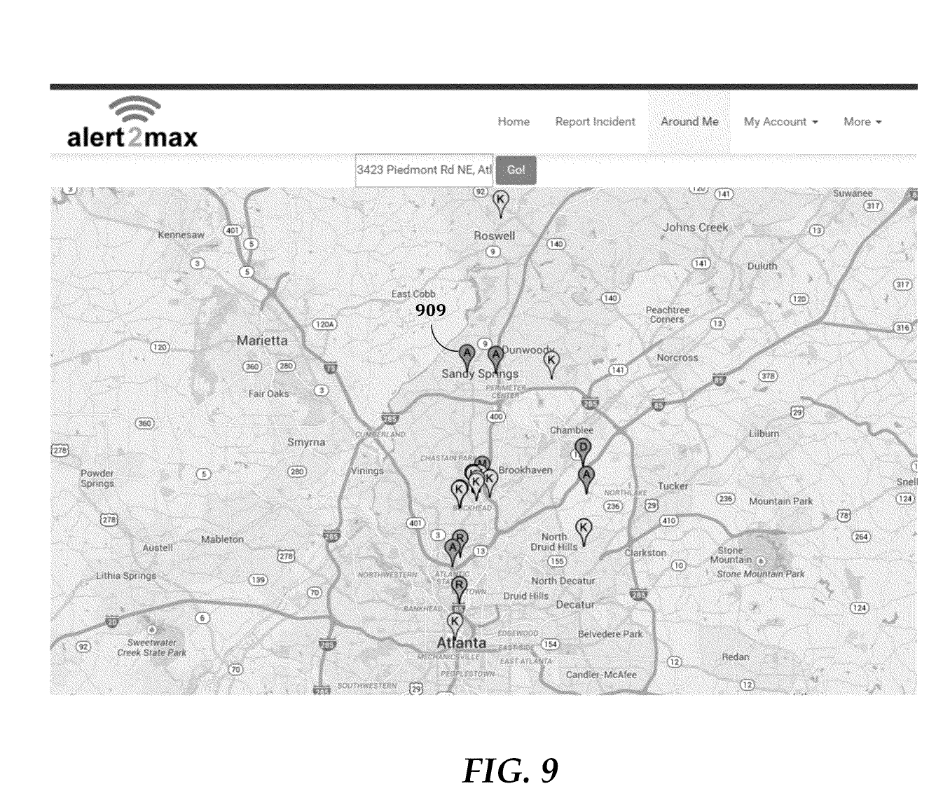

FIG. 8 illustrates an interface that enables user 105 to view reports submitted through platform 100. The reports may be specific to the user or, in some embodiments, general to a location associated with or specified by the user 105. For example, as illustrated in FIG. 9, platform 100 may compile incidents reported based on geographical regions. The incidents may be depicted on a map with labels 909 associated with the incident type. For example, an “A” may depict an accident incident, an “R” may depict a robbery, and a “K” may depict a kidnapping.

The map need not be visible to user 105 of platform 100. For example, platform 100 may be operating as a background process on a user's mobile device. Then, when it is detected that a user is in a zone or region with recently reported incidents, an alert may be issued to the user or the user's contacts (e.g., profiled people). Moreover, platform 100 may access various databases to retrieve incident information associated with particular zones or regions (e.g., government reporting systems). The retrieved data may be used to assess a ‘danger’ or ‘alert’ level to be issued to user 105 when it is detected that the user is within a zone with a high amount of incidents reported. Further still, in some embodiments, the user's profiled contacts may be alerted that user 105 has entered into a ‘dangerous’ zone or region.

FIG. 10 is a block diagram of a system including computing device 1000. Consistent with an embodiment of the disclosure, the aforementioned memory storage and processing unit may be implemented in a computing device, such as computing device 1000 of FIG. 10. Any suitable combination of hardware, software, or firmware may be used to implement the memory storage and processing unit. For example, the memory storage and processing unit may be implemented with computing device 1000 or any of other computing devices 1018, in combination with computing device 1000. The aforementioned system, device, and processors are examples and other systems, devices, and processors may comprise the aforementioned memory storage and processing unit, consistent with embodiments of the disclosure.

IV. Platform Architecture

Platform 100 may be embodied as, for example, but not be limited to, a website, a web application, a desktop application, and a mobile application compatible with a computing device. The computing device may comprise, but not be limited to, a desktop computer, laptop, a tablet, or mobile telecommunications device. Moreover, platform 100 may be hosted on a centralized server, such as, for example, a cloud computing service.

Although method 200 has been described to be performed by a computing device 1000, it should be understood that, in some embodiments, different operations may be performed by different networked elements in operative communication with computing device 1000.

Embodiments of the present disclosure may comprise a system having a memory storage and a processing unit. The processing unit coupled to the memory storage, wherein the processing unit is configured to perform the stages of method 200.

With reference to FIG. 10, a system consistent with an embodiment of the disclosure may include a computing device, such as computing device 1000. In a basic configuration, computing device 1000 may include at least one processing unit 1002 and a system memory 1004. Depending on the configuration and type of computing device, system memory 1004 may comprise, but is not limited to, volatile (e.g. random access memory (RAM)), non-volatile (e.g. read-only memory (ROM)), flash memory, or any combination. System memory 1004 may include operating system 1005, one or more programming modules 1006, and may include a program data 1007. Operating system 1005, for example, may be suitable for controlling computing device 1000's operation. In one embodiment, programming modules 1006 may include software application 1020. Furthermore, embodiments of the disclosure may be practiced in conjunction with a graphics library, other operating systems, or any other application program and is not limited to any particular application or system. This basic configuration is illustrated in FIG. 10 by those components within a dashed line 1008.

Computing device 1000 may have additional features or functionality. For example, computing device 1000 may also include additional data storage devices (removable and/or non-removable) such as, for example, magnetic disks, optical disks, or tape. Such additional storage is illustrated in FIG. 10 by a removable storage 1009 and a non-removable storage 1010. Computer storage media may include volatile and nonvolatile, removable and non-removable media implemented in any method or technology for storage of information, such as computer readable instructions, data structures, program modules, or other data. System memory 1004, removable storage 1009, and non-removable storage 1010 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1000. Any such computer storage media may be part of device 1000. Computing device 1000 may also have input device(s) 1012 such as a keyboard, a mouse, a pen, a sound input device, a touch input device, etc. Output device(s) 1014 such as a display, speakers, a printer, etc. may also be included. The aforementioned devices are examples and others may be used.

Computing device 1000 may also contain a communication connection 1016 that may allow device 1000 to communicate with other computing devices 1018, such as over a network in a distributed computing environment, for example, an intranet or the Internet. Communication connection 1016 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1004, including operating system 1005. While executing on processing unit 1002, programming modules 1006 (e.g., software application 1020) may perform processes including, for example, one or more method 200's stages as described above. The aforementioned process is an example, and processing unit 1002 may perform other processes. Other programming modules that may be used in accordance with embodiments of the present disclosure may include electronic mail and contacts applications, word processing applications, spreadsheet applications, database applications, slide presentation applications, drawing or computer-aided application programs, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

All rights including copyrights in the code included herein are vested in and the property of the Applicant. The Applicant retains and reserves all rights in the code included herein, and grants permission to reproduce the material only in connection with reproduction of the granted patent and for no other purpose.

V. Claims

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. A method comprising:
Receiving an alert specification;
Creating an alert based on the alert specification;
Calculating a communication radius based on the alert specification;
Distributing the alert within the communication radius;
Determining the alert has been resolved;
Expanding the communication radius if the alert has not been resolved; and
Distributing the alert within the expanded communications radius.

2. A platform as specified in the description.

3. The platform of claim 1, as further illustrated in the FIGURES.

4. A method operative with the platform of claim 1 as specified in the description.

5. The method of claim 3, as further specified by the FIGURES.

6. A method as specified by method 200 in the description.

7. The method of claim 3, as further specified by the FIGURES.

8. A system operative to perform the method of claim 3.

9. A system configured to enable the platform of claim 1.

10. As system as specified in the description and the FIGURES.
